(19) United States
(12) Patent Application Publication
(10) Pub. No.: US 2026/0044746 A1
(43) Pub. Date: Feb. 12, 2026

(54) APPARATUS AND METHOD FOR HIERARCHICAL HYBRID NEURAL ARCHITECTURE SEARCH

(71) Applicant: ELECTRONICS AND TELECOMMUNICATIONS RESEARCH INSTITUTE, Daejeon (KR)

(72) Inventors: Ji-Young KWAK, Gwangju (KR); Seon-Tae KIM, Daejeon (KR); Hong-Soog KIM, Daejeon (KR); Jae-Bok PARK, Daejeon (KR); Jin-Wuk SEOK, Daejeon (KR); Kyung Hee LEE, Daejeon (KR); Chang-Sik CHO, Daejeon (KR)

(73) Assignee: ELECTRONICS AND TELECOMMUNICATIONS RESEARCH INSTITUTE, Daejeon (KR)

(21) Appl. No.: 18/958,485

(22) Filed: Nov. 25, 2024

(30) Foreign Application Priority Data
Aug. 8, 2024 (KR) 10-2024-0105850

(51) Int. Cl. G06N 3/0985

(52) U.S. Cl. CPC G06N 3/0985

(57) ABSTRACT

Disclosed herein is an apparatus and method for a hierarchical hybrid neural architecture search. The apparatus assigns a data subset per cluster by retrieving semantic clustering information with meta-feature information similar to target data for a neural architecture search from a large-scale dataset, determines optimal meta-blocks by performing top-k meta-blocks search in the data subset assigned per cluster, scales the size of a neural network model, and determines a neural network architecture based on semantic information of meta-features obtained by combining the optimal meta-blocks.

### CROSS REFERENCE TO RELATED APPLICATION

This application claims the benefit of Korean Patent Application No. 10-2024-0105850, filed Aug. 8, 2024, which is hereby incorporated by reference in its entirety into this application.

### BACKGROUND OF THE INVENTION

### 1. Technical Field

The present disclosure relates generally to neural network technology, and more particularly to technology for hierarchical hybrid neural architecture search.

### 2. Description of the Related Art

Existing Neural Architecture Search (NAS) methods generally aim to find a single architecture that achieves best performance by optimizing task-related learning objectives, such as accuracy. NAS provides a great possibility, but it is not easy to directly search for an architecture in a large-scale task due to the enormous computational requirements of most of the existing NAS methods. Also, the existing NAS methods generally work well for the search for an architecture for a single task because they are performed only for a specific task, but a problem is caused when multiple datasets or multiple tasks are present. Generally, an architecture for a new task is searched from scratch, but this is inefficient or inflexible in actual application scenarios. Therefore, an architecture found in another task can be used, but it is difficult to achieve the required application service performance because the architecture is not an optimal architecture.

Therefore, it is inefficient to apply an existing NAS function suitable for a specific task to various Artificial Intelligence (AI) tasks in real life, and a lot of learning data is required therefor. The various NAS methods show similar performance on a source dataset (CIFAR10), but their transfer performance to a large-scale dataset (ImageNet1K) significantly varies. Therefore, a flexible and efficient neural architecture search method capable of supporting a domain expert architecture is required so that a sophisticated architecture can be used for difficult data samples generally involving high architecture-related costs and so that a shallow architecture can be used for easy data samples.

Meanwhile, U.S. Pat. No. 1,038,0498, titled “Platform services to enable one-click execution of the end-to-end sequence of modeling steps”, discloses a system and method for generating an automated machine-learning model by selecting features and parameters based on a similarity score determined by comparing model requirements of a user with previously stored model requirements of multiple users.

### SUMMARY OF THE INVENTION

An object of the present disclosure is to provide an efficient and flexible neural architecture search function by considering an infinite search space and limitations of learning resources.

Another object of the present disclosure is to improve inefficient existing NAS methods by applying the idea of selecting a proxy set of a large-scale dataset and a suitable combination of various search strategies.

A further object of the present disclosure is to provide a hierarchical neural architecture search (hierarchical meta-architecture search) function in which the efficiency and scalability of a domain expert architecture search capable of achieving high accuracy at customized inference costs are taken into consideration.

In order to accomplish the above objects, an apparatus for a hierarchical hybrid neural architecture search according to an embodiment of the present disclosure includes one or more processors and memory for storing at least one program executed by the one or more processors, and the at least one program assigns a data subset per cluster by retrieving semantic clustering information with meta-feature information similar to target data for a neural architecture search from a large-scale dataset, determines optimal meta-blocks by performing top-k meta-blocks search in the data subset assigned per cluster, scales the size of a neural network model, and determines a neural network architecture based on semantic information of meta-features obtained by combining the optimal meta-blocks.

Here, the at least one program may perform semantic clustering of multiview meta-features for distinguishing a proxy set from a large-scale dataset.

Here, the at least one program may generate semantic clustering information including vector information of meta-features of a pretrained latent embedding space based on the semantic clustering.

Here, the at least one program may assign the meta-feature information similar to the target data for the neural architecture search as the data subset per cluster by performing task similarity representation learning based on vector information of meta-features provided from a proxy set of the large-scale dataset.

Here, the at least one program may search for a preset number of top optimal meta-blocks with a high probability, among predicted meta-blocks, by performing the top-k meta-blocks search.

Here, the at least one program may perform the top-k meta-blocks search by determining a routing branch for mapping to a feature group of each layer that is preset for each feature of data in the data subset per cluster.

Here, the at least one program may perform the top-k meta-blocks search by utilizing a block-wise search function using supervised learning according to a data subset based on the meta-feature information and a multiple-branch hybrid method for selecting a branch of an inference path from multiple branches based on the routing branch.

Here, the meta-feature information may be configured in the form of a feature matrix based on instance representation information, which represents features of a dataset in a meta-feature latent embedding space, and cluster representation information, which represents the normal distribution of data of the dataset.

Here, the at least one program may combine the optimal meta-blocks and generate the semantic information based on multiview meta-features extracted by applying a result of scaling the size of the neural network model to a reference base architecture.

Here, the at least one program may combine the optimal meta-blocks using a predefined Markov-chain-based evolution algorithm and scale the size of the neural network model.

Also, in order to accomplish the above objects, a method for a hierarchical hybrid neural architecture search, performed by an apparatus for the hierarchical hybrid neural architecture search, according to an embodiment of the present disclosure includes assigning a data subset per cluster by retrieving semantic clustering information with meta-feature information similar to target data for a neural architecture search from a large-scale dataset; determining optimal meta-blocks by performing top-k meta-blocks search in the data subset assigned per cluster; and scaling the size of a neural network model and determining a neural network architecture based on semantic information of meta-features obtained by combining the optimal meta-blocks.

Here, the method may further comprise performing semantic clustering of multiview meta-features for distinguishing a proxy set from a large-scale dataset.

Here, performing the semantic clustering may comprise generating semantic clustering information including vector information of meta-features of a pretrained latent embedding space based on the semantic clustering.

Here, assigning the data subset may comprise assigning the meta-feature information similar to the target data for the neural architecture search as the data subset per cluster by performing task similarity representation learning based on vector information of meta-features provided from a proxy set of the large-scale dataset.

Here, determining the optimal meta-blocks may comprise searching for a preset number of top optimal meta-blocks with a high probability, among predicted meta-blocks, by performing the top-k meta-blocks search.

Here, determining the optimal meta-blocks may comprise performing the top-k meta-blocks search by determining a routing branch for mapping to a feature group of each layer that is preset for each feature of data in the data subset per cluster.

Here, determining the optimal meta-blocks may comprise performing the top-k meta-blocks search by utilizing a block-wise search function using supervised learning according to a data subset based on the meta-feature information and a multiple-branch hybrid method for selecting a branch of an inference path from multiple branches based on the routing branch.

Here, the meta-feature information may be configured in the form of a feature matrix based on instance representation information, which represents features of a dataset in a meta-feature latent embedding space, and cluster representation information, which represents the normal distribution of data of the dataset.

Here, determining the neural network architecture may comprise combining the optimal meta-blocks and generating the semantic information based on multiview meta-features extracted by applying a result of scaling the size of the neural network model to a reference base architecture.

Here, determining the neural network architecture may comprise combining the optimal meta-blocks using a predefined Markov-chain-based evolution algorithm and scaling the size of the neural network model.

### BRIEF DESCRIPTION OF THE DRAWINGS

The above and other objects, features, and advantages of the present disclosure will be more clearly understood from the following detailed description taken in conjunction with the accompanying drawings, in which:

FIG. 1 is a block diagram illustrating an apparatus for a hierarchical hybrid neural architecture search according to an embodiment of the present disclosure;

FIG. 2 is a flowchart illustrating a method for a hierarchical hybrid neural architecture search according to an embodiment of the present disclosure;

FIG. 3 is a view illustrating a process of searching for the top-k meta-blocks of a semantic cluster prototype according to an embodiment of the present disclosure;

FIGS. 4 and 5 are views illustrating a mapping expert routing structure based on multiview meta-feature-based contrastive data subsets according to an embodiment of the present disclosure;

FIG. 6 is a view illustrating a process of mapping to an expert based on clustering information of a data subset according to an embodiment of the present disclosure;

FIG. 7 is a view illustrating a block-wise search method for a data subset according to an embodiment of the present disclosure;

FIG. 8 is a view illustrating a multiple-branch hybrid method for a data subset according to an embodiment of the present disclosure;

FIGS. 9 to 14 are views illustrating a hierarchical hybrid neural architecture search (hierarchical meta-architecture search) process based on semantic information of meta-features according to an embodiment of the present disclosure; and

FIG. 15 is a view illustrating a computer system according to an embodiment of the present disclosure.

### DESCRIPTION OF THE PREFERRED EMBODIMENTS

The present disclosure will be described in detail below with reference to the accompanying drawings. Repeated descriptions and descriptions of known functions and configurations which have been deemed to unnecessarily obscure the gist of the present disclosure will be omitted below. The embodiments of the present disclosure are intended to fully describe the present disclosure to a person having ordinary knowledge in the art to which the present disclosure pertains. Accordingly, the shapes, sizes, etc. of components in the drawings may be exaggerated in order to make the description clearer.

Throughout this specification, the terms “comprises” and/or “comprising” and “includes” and/or “including” specify the presence of stated elements but do not preclude the presence or addition of one or more other elements unless otherwise specified.

Hereinafter, a preferred embodiment of the present disclosure will be described in detail with reference to the accompanying drawings.

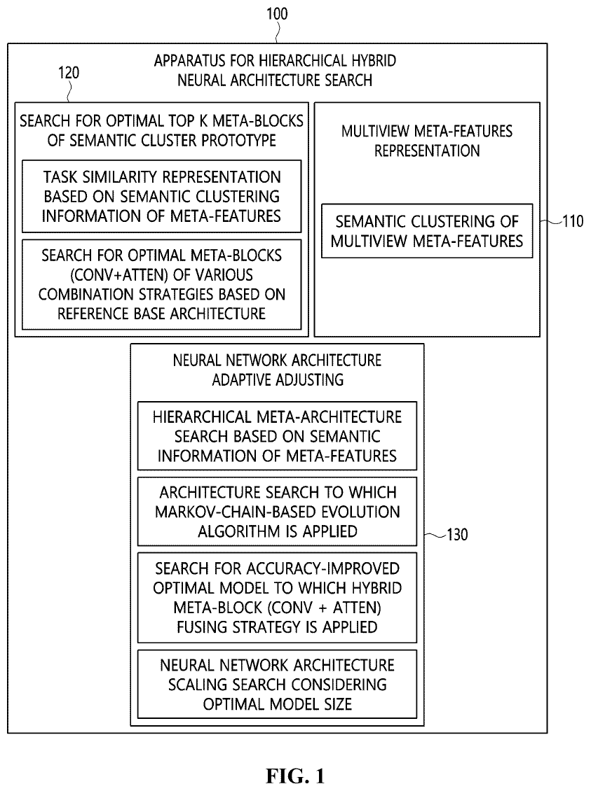

FIG. 1 is a block diagram illustrating an apparatus for a hierarchical hybrid neural architecture search according to an embodiment of the present disclosure.

Referring to FIG. 1, the apparatus 100 for a hierarchical hybrid neural architecture search according to an embodiment of the present disclosure may perform a hierarchical hybrid neural architecture search (hierarchical meta-architecture search) method in the form of conceptual incremental learning in which the efficiency and scalability of a domain expert architecture search is taken into consideration by utilizing a proxy set of a large-scale dataset and a suitable combination of various search strategies, unlike an existing large-scale NAS method of a strategy of random sampling in a large-scale dataset.

The apparatus 100 for a hierarchical hybrid neural architecture search includes a multiview meta-feature representation processing unit 110 for providing semantic clustering information of meta-features, a top-k meta-blocks search unit 120 for supporting a function to search for optimal meta-blocks (conv+atten) of various combination strategies, and a neural network architecture adaptive adjustment unit 130 for performing a hierarchical hybrid neural architecture search (hierarchical meta-architecture search) function depending on the semantic information of meta-features.

The multiview meta-feature representation processing unit 110 may include multiview meta-features representation submodules for providing semantic clustering information of meta-features.

The multiview meta-feature representation processing unit 110 may perform semantic clustering of multiview meta-features in order to provide semantic clustering information of meta-features for distinguishing a proxy set from a large-scale dataset.

Here, the multiview meta-feature representation processing unit 110 may generate semantic clustering information including vector information of meta-features of a pretrained latent embedding space based on the semantic clustering by performing a multiview meta-feature representation function.

Here, the multiview meta-feature representation processing unit 110 may retrieve semantic clustering information with meta-feature information similar to the target data for a neural architecture search from a large-scale dataset.

Here, the multiview meta-feature representation processing unit 110 performs task similarity representation learning based on vector information of meta-features provided from the proxy set of the large-scale dataset, thereby assigning the meta-feature information similar to the target data for the neural architecture search as a data subset per cluster prototype.

Here, the meta-features information may be configured in the form of a feature matrix based on instance representation information, which represents the features of a dataset in the meta-feature latent embedding space, and cluster representation information, which represents the normal distribution of data of the dataset.

The top-k meta-blocks search unit 120 may perform a search for optimal top-k meta-blocks of a semantic cluster prototype by which a function to search for the optimal meta-blocks (conv+atten) of various combination strategies is supported.

The top-k meta-blocks search unit 120 performs top-k meta-blocks search on a data subset assigned per cluster prototype assigned to the neural architecture search data, thereby determining optimal meta-block information.

Here, the top-k meta-blocks search unit 120 may search for a preset number of (top-k) optimal meta-blocks with a high probability, among predicted meta-blocks, using the top-k meta-blocks search.

Here, the top-k meta-blocks search unit 120 may perform the top-k meta-blocks search by determining a routing branch for mapping to a feature group of each layer that is preset for each feature of data in the data subset per cluster.

Here, the top-k meta-blocks search unit 120 may fix a reference base architecture as a reference neural network architecture.

Here, the top-k meta-blocks search unit 120 may search for optimal meta-blocks (conv+atten) based on various combination strategies by including convolution blocks.

Here, the top-k meta-blocks search unit 120 may determine the optimal meta-block information of the target data for the neural architecture search by searching for the top-k meta-blocks of a corresponding semantic cluster prototype, among hybrid blocks (conv+atten) based on various combination strategies, by including convolution blocks by default.

The neural network architecture adaptive adjustment unit 130 may perform a hierarchical hybrid neural architecture search (hierarchical meta-architecture search) function based on the semantic information of the meta-features.

Here, the neural network architecture adaptive adjustment unit 130 may scale the size of a neural network model and determine a neural network architecture based on the semantic information of meta-features obtained by combining the optimal meta-blocks.

Here, the neural network architecture adaptive adjustment unit 130 may scale the size of the neural network model and perform adaptive adjustment of a hybrid neural network architecture to combine the optimal meta-blocks.

Here, the neural network architecture adaptive adjustment unit 130 may perform a hierarchical hybrid neural architecture search to search for both a strategy of combining a base model with the found optimal meta-blocks and a strategy of scaling the size of the neural network model in order to achieve promising performance.

Here, the neural network architecture adaptive adjustment unit 130 may apply a hybrid meta-block (conv+atten) fusing strategy in consideration of improvement of the accuracy performance of the neural network.

Here, the neural network architecture adaptive adjustment unit 130 may perform a neural network architecture scaling search in order to determine an optimal model size considering neural network accuracy and FLOPS.

Here, the neural network architecture adaptive adjustment unit 130 may combine the optimal meta-blocks (conv+atten) using a predefined Markov-chain-based evolution algorithm and generate semantic information based on multiview meta-features extracted by applying the result of scaling the size of the neural network model to the reference base architecture.

For example, the Markov-chain is a stochastic model in which the result of every event is affected by the result of the previous event.

Here, the neural network architecture adaptive adjustment unit 130 may automatically generate a domain expert architecture based on the semantic information of the meta-features.

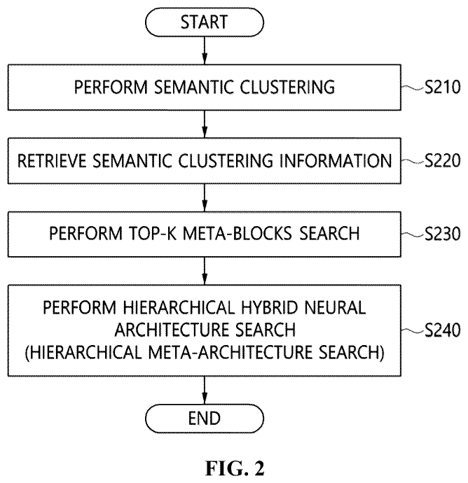

FIG. 2 is a flowchart illustrating a method for a hierarchical hybrid neural architecture search according to an embodiment of the present disclosure.

Referring to FIG. 2, in the method for a hierarchical hybrid neural architecture search according to an embodiment of the present disclosure, first, semantic clustering may be performed at step S210.

That is, at step S210, semantic clustering of multiview meta-features, through which semantic clustering information of meta-features for distinguishing a proxy set from a large-scale dataset is provided, may be performed.

Here, at step S210, a multiview meta-feature representation function is performed, whereby semantic clustering information including vector information of meta-features of a pretrained latent embedding space may be generated based on the semantic clustering.

Also, in the method for a hierarchical hybrid neural architecture search according to an embodiment of the present disclosure, semantic clustering information may be retrieved at step S220.

That is, at step S220, semantic clustering information with meta-feature information similar to target data for a neural architecture search may be retrieved from a large-scale dataset.

Here, at step S220, a cluster prototype of similar meta-features may be assigned based on the semantic clustering information of the meta-features.

Here, at step S220, task similarity representation learning is performed based on the vector information of meta-features provided from the proxy set of the large-scale dataset, and the meta-feature information similar to the target data for the neural architecture search may be assigned as a data subset per cluster prototype.

Here, the meta-features information may be configured in the form of a feature matrix based on instance representation information, which represents the features of a dataset in a meta-feature latent embedding space, and cluster representation information, which represents the normal distribution of data of the dataset.

Also, in the method for a hierarchical hybrid neural architecture search according to an embodiment of the present disclosure, top-k meta-blocks search may be performed at step S230.

That is, at step S230, the top-k meta-blocks search is performed on the data subset assigned per cluster prototype assigned to the neural architecture search data, whereby optimal meta-block information may be determined.

Here, at step S230, for a corresponding cluster prototype, optimal meta-blocks (conv+atten) of various combination strategies, which are architecture building blocks, may be searched for.

Here, at step S230, the top-k meta-blocks search may be performed for each cluster prototype.

Here, at step S230, a preset number of (top-k) optimal meta-blocks with a high probability, among predicted meta-blocks, may be searched for using the top-k meta-blocks search.

Here, at step S230, a routing branch for mapping to a feature group of each layer that is preset for each feature of data in the data subset per cluster is determined, whereby the top-k meta-blocks search may be performed.

Here, at step S230, a reference base architecture may be fixed as a reference neural network architecture.

Here, at step S230, optimal meta-blocks (conv+atten) based on various combination strategies may be searched for by including convolution blocks.

Here, at step S230, the optimal meta-block information of the target data for the neural architecture search may be determined by searching for the top-k meta-blocks of the corresponding semantic cluster prototype, among hybrid blocks (conv+atten) based on various combination strategies, by including convolution blocks by default.

Also, in the method for a hierarchical hybrid neural architecture search according to an embodiment of the present disclosure, a hierarchical hybrid neural architecture search based on the semantic information of the meta-features may be performed at step S240.

That is, at step S240, the size of a neural network model may be scaled, and a neural network architecture may be determined based on the semantic information of the meta-features obtained by combining the optimal meta-blocks.

Here, at step S240, a strategy of combining the base model with the found optimal meta-blocks may be designed such that promising performance can be finally achieved by adaptive adjustment of the hybrid neural network architecture.

Here, at step S240, a hierarchical hybrid neural architecture search (hierarchical meta-architecture search) function, which also searches for a strategy of scaling the size of the neural network model, may be performed.

Here, at step S240, a domain expert architecture according to the semantic information of the meta-features may be automatically generated based on the strategy of combining the optimal meta-blocks and the hierarchical hybrid neural architecture search function.

Here, at step S240, the size of the neural network model may be scaled, and hybrid neural network architecture adaptive adjustment for combining the optimal meta-blocks may be performed.

Here, at step S240, the hierarchical hybrid neural architecture search, through which both the strategy of combining the base model with the found optimal meta-blocks and the strategy of scaling the size of the neural network model are searched for, may be performed such that promising performance is achieved.

Here, at step S240, a hybrid meta-block (conv+atten) fusing strategy may be applied in consideration of improvement of the accuracy performance of the neural network.

Here, at step S240, a neural network architecture scaling search may be performed in order to determine an optimal model size considering neural network accuracy and FLOPS.

Here, at step S240, the optimal meta-blocks (conv+atten) are combined using a predefined Markov-chain-based evolution algorithm, and semantic information may be generated based on multiview meta-features extracted by applying the result of scaling the size of the neural network model to the reference base architecture.

For example, the Markov-Chain is a stochastic model in which the result of every event is affected by the result of the previous event.

Here, at step S240, a domain expert architecture based on the semantic information of the meta-features may be automatically generated.

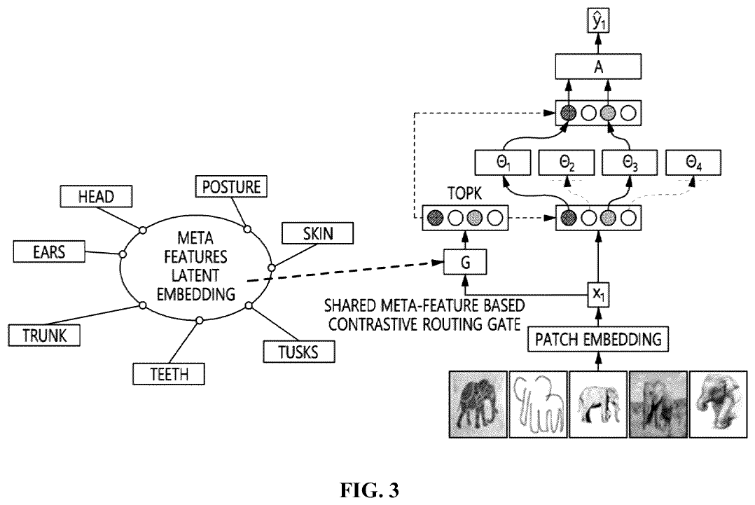

FIG. 3 is a view illustrating a process of searching for the top-k meta-blocks of a semantic cluster prototype according to an embodiment of the present disclosure.

Referring to FIG. 3, it can be seen that a process of searching for the top-k meta-blocks of a semantic cluster prototype is illustrated.

The shared meta-feature-based contrastive routing gate of a meta-architecture neural network illustrated in FIG. 3 may determine a routing branch by mapping input image data to an expert responsible for potentially similar dataset feature groups based on main meta-feature information configured with a combination of sub-features for the visual characteristics of datasets in a meta-feature latent embedding space.

Accordingly, routing based on differentiated features between normalized image patches of various visual features is performed in a data learning process.

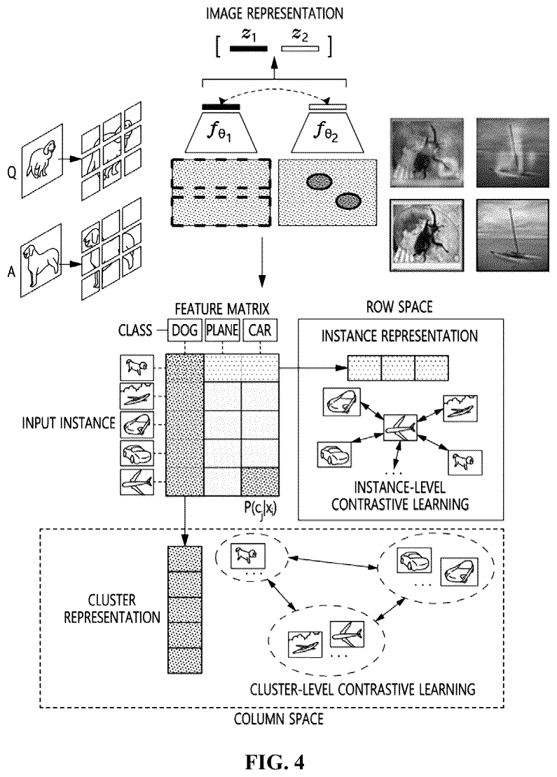

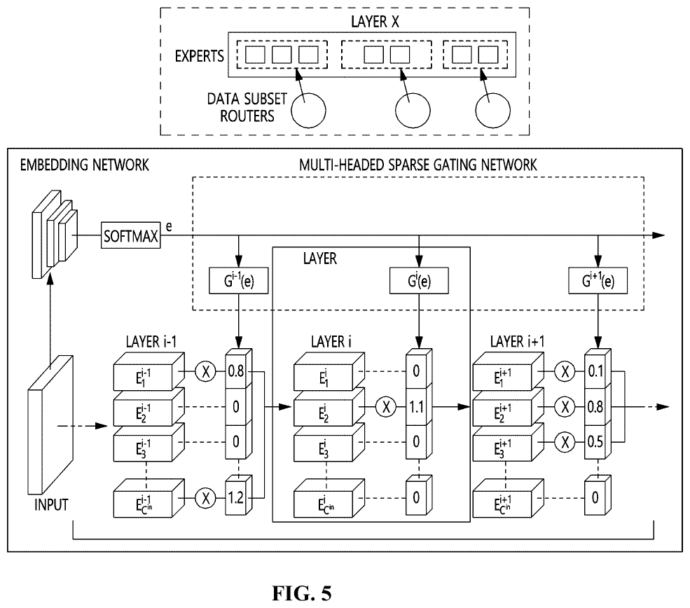

FIGS. 4 and 5 are views illustrating a mapping expert routing structure based on multiview meta-feature-based contrastive data subsets according to an embodiment of the present disclosure.

Referring to FIGS. 4 and 5, it can be seen that the mapping expert routing structure based on the multiview meta-feature-based contrastive data subsets is applied to search for optimal meta-blocks in the step of searching for the top-k meta-blocks of a semantic cluster prototype.

Here, it can be seen that the apparatus for a hierarchical hybrid neural architecture search configures the meta-feature latent embedding space illustrated in FIG. 3 in the form of a feature matrix based on instance representation information, which represents various visual features of a dataset image patch, and cluster representation information, which represents the normal distribution of data of a dataset.

Referring to FIG. 5, it can be seen that the apparatus for a hierarchical hybrid neural architecture search performs expert routing for searching for optimal meta-blocks based on the features of data subsets sorted in order of high probability in a corresponding feature matrix.

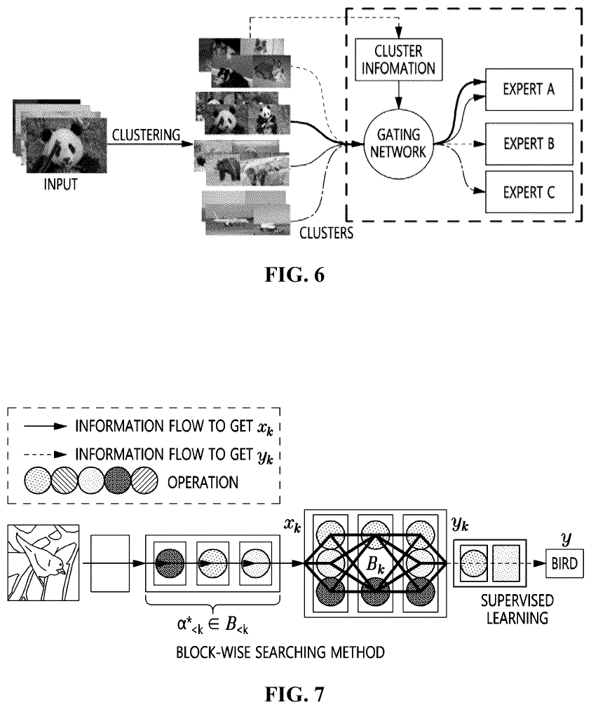

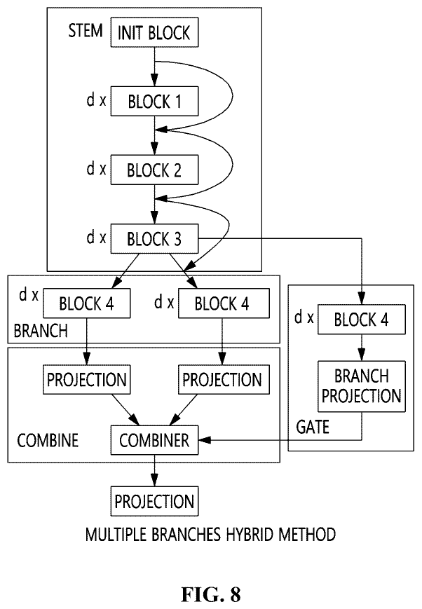

FIG. 6 is a view illustrating a process of mapping a data subset to an expert according to an embodiment of the present disclosure. FIG. 7 is a view illustrating a block-wise search method for a data subset according to an embodiment of the present disclosure. FIG. 8 is a view illustrating a multiple-branch hybrid method for a data subset according to an embodiment of the present disclosure.

Also, a block-wise search method or a multiple-branch hybrid method according to semantically similar data subsets may be performed based on meta-feature information, as illustrated in FIGS. 6, 7, and 8.

Referring to FIG. 6 and FIG. 3, it can be seen that, when a semantically similar

data subset image is input, it is mapped to a corresponding expert in each layer of a meta-architecture neural network while data learning is being performed.

Here, it can be seen that the data subset image mapped to the corresponding expert enables searching for meta-blocks suitable for data subsets with differentiated features while mitigating a negative knowledge transfer phenomenon.

Referring to FIG. 7, it can be seen that the apparatus for a hierarchical hybrid neural architecture search performs a block-wise search method using supervised learning according to a semantically similar data subset based on meta-feature information.

Referring to FIG. 8, the apparatus for a hierarchical hybrid neural architecture search may perform a multiple-branch hybrid method according to a semantically similar data subset based on meta-feature information.

Here, it can be seen that the apparatus for a hierarchical hybrid neural architecture search builds a meta-architecture neural network structure including multiple branches that are routed differently depending on input data subsets, a routing gate for selecting a branch of an inference path specialized for the corresponding data subsets, and a combiner for aggregating the outputs of the multiple branches for final prediction. Here, the meta-architecture neural network structure may perform the block-wise search function of FIG. 7 and the multiple-branch hybrid method of FIG. 8 by considering a learning resource environment or enabling a gradual optimal meta-blocks search using a module-wise search method.

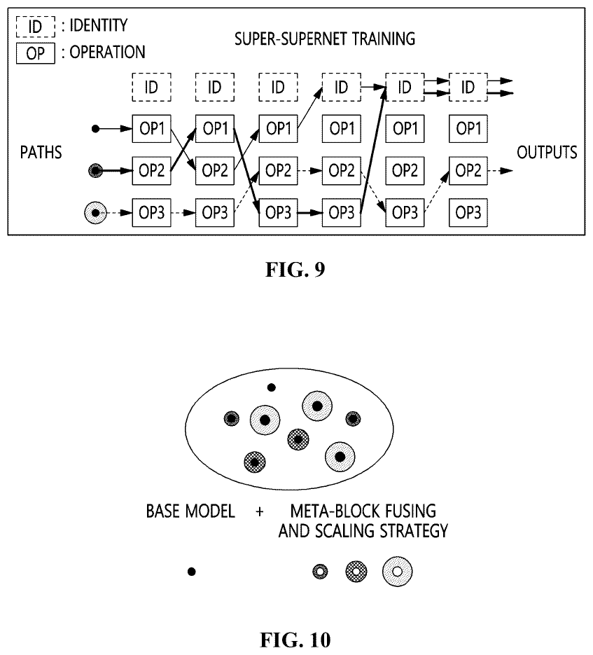

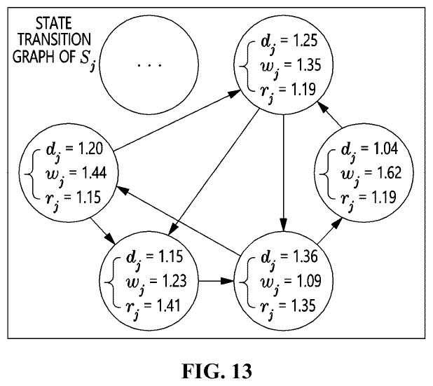

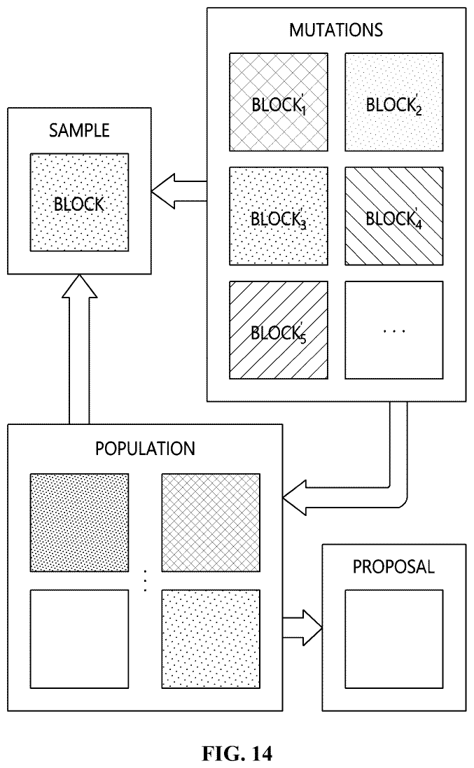

FIGS. 9 to 14 are views illustrating a hierarchical hybrid neural architecture search (hierarchical meta-architecture search) process based on semantic information of meta-features according to an embodiment of the present disclosure.

Referring to FIG. 9, it can be seen that super-supernet training according to an embodiment of the present disclosure is illustrated.

Here, it can be seen that a process in which the apparatus for a hierarchical hybrid neural architecture search generates models of various sizes using super-supernet training is illustrated.

Here, the super-supernet training of the apparatus for a hierarchical hybrid neural architecture search may perform a strategy of combining a base model with found optimal meta-blocks through a Markov-chain-based evolution algorithm.

Here, the super-supernet training may automatically generate a neural network model having a suitable size by performing a generalized training process in the form of a hierarchical hybrid neural architecture search (hierarchical meta-architecture search) (HybridNet (conv+atten) structure) that also searches for a strategy of scaling the size of the neural network model.

Referring to FIG. 10, it can be seen that a strategy of combining a base model with found optimal meta-blocks through the Markov-chain-based evolution algorithm is illustrated.

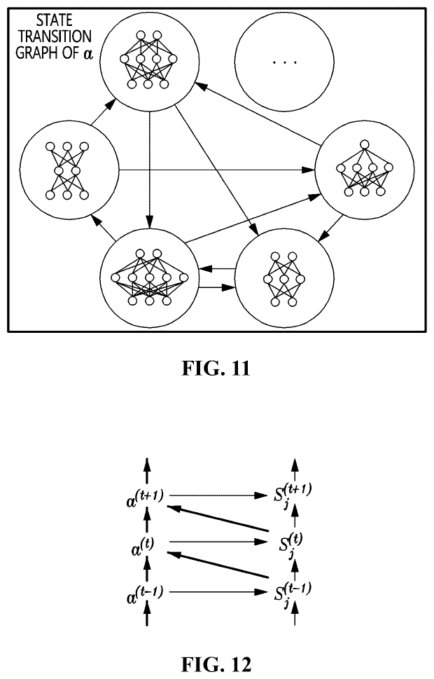

Referring to FIGS. 11 to 14, it can be seen that, based on the optimal meta-block information determined in a top-k meta-blocks search step, the apparatus for a hierarchical hybrid neural architecture search performs a hierarchical hybrid neural architecture search (hierarchical meta-architecture search) according to semantic information based on meta-feature information.

According to the hierarchical hybrid neural architecture search (hierarchical meta-architecture search) method in the form of conceptual incremental learning, a multiview meta-feature-based neural network architecture adaptive adjustment function that utilizes a proxy set of a large-scale dataset and a suitable combination of various search strategies may be performed in order to establish a meta-architecture according to multiview meta-features extracted by referring to a reference base convolution model.

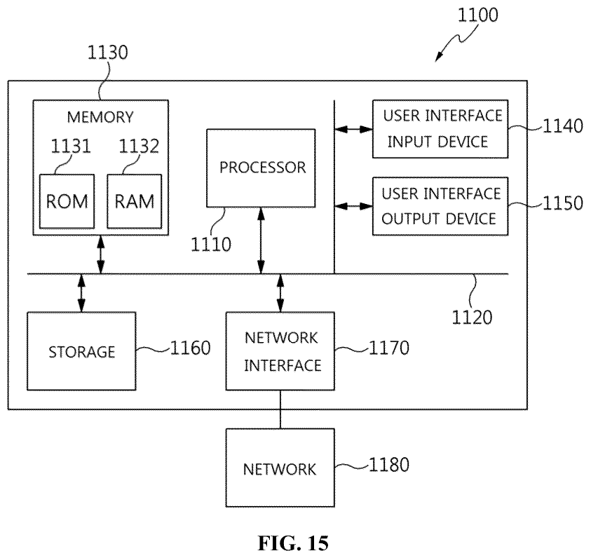

FIG. 15 is a view illustrating a computer system according to an embodiment of the present disclosure.

Referring to FIG. 15, the apparatus 100 for a hierarchical hybrid neural architecture search according to an embodiment of the present disclosure may be implemented in a computer system 1100 including a computer-readable recording medium. As illustrated in FIG. 15, the computer system 1100 may include one or more processors 1110, memory 1130, a user-interface input device 1140, a user-interface output device 1150, and storage 1160, which communicate with each other via a bus 1120. Also, the computer system 1100 may further include a network interface 1170 connected to a network 1180. The processor 1110 may be a central processing unit or a semiconductor device for executing processing instructions stored in the memory 1130 or the storage 1160. The memory 1130 and the storage 1160 may be any of various types of volatile or nonvolatile storage media. For example, the memory may include ROM 1131 or RAM 1132.

The apparatus for a hierarchical hybrid neural architecture search according to an embodiment of the present disclosure includes one or more processors 1110 and memory 1130 for storing at least one program executed by the one or more processors 1110, and the at least one program assigns a data subset per cluster by retrieving semantic clustering information with meta-feature information similar to target data for a neural architecture search from a large-scale dataset, determines optimal meta-blocks by performing top-k meta-blocks search in the data subset assigned per cluster, scales the size of a neural network model, and determines a neural network architecture based on semantic information of meta-features obtained by combining the optimal meta-blocks.

Here, the at least one program may perform semantic clustering of multiview meta-features for distinguishing a proxy set from a large-scale dataset.

Here, the at least one program may generate semantic clustering information including vector information of meta-features of a pretrained latent embedding space based on the semantic clustering.

Here, the at least one program performs task similarity representation learning based on vector information of meta-features provided from the proxy set of the large-scale dataset, thereby assigning the meta-feature information similar to the target data for the neural architecture search as the data subset per cluster.

Here, the at least one program may search for a preset number of top optimal meta-blocks with a high probability, among predicted meta-blocks, by performing the top-k meta-blocks search.

Here, the at least one program may perform the top-k meta-blocks search by determining a routing branch for mapping to a feature group of each layer that is preset for each feature of data in the data subset per cluster.

Here, the at least one program may perform the top-k meta-blocks search by utilizing a block-wise search function using supervised learning according to a data subset based on the meta-feature information and a multiple-branch hybrid method for selecting a branch of an inference path from multiple branches based on the routing branch.

Here, the meta-feature information may be configured in the form of a feature matrix based on instance representation information, which represents the features of a dataset in the meta-feature latent embedding space, and cluster representation information, which represents the normal distribution of data of the dataset.

Here, the at least one program may combine the optimal meta-blocks and generate the semantic information based on multiview meta-features extracted by applying a result of scaling the size of the neural network model to a reference base architecture.

Here, the at least one program may combine the optimal meta-blocks using a predefined Markov-chain-based evolution algorithm and scale the size of the neural network model.

The apparatus for a hierarchical hybrid neural architecture search according to an embodiment of the present disclosure may improve an inefficient existing large-scale NAS method in consideration of an infinite search space and limitations of learning resources.

Here, the apparatus for a hierarchical hybrid neural architecture search searches for architectural building blocks in a proxy set of a large-scale dataset, transfers the blocks to a larger dataset, and suitably combines various search strategies, thereby supporting the efficiency and scalability of a domain expert architecture search based on semantic information of meta-features.

The present disclosure may provide an efficient and flexible neural architecture search function by considering an infinite search space and limitations of learning resources.

Also, the present disclosure may improve inefficient existing NAS methods by applying the idea of selecting a proxy set of a large-scale dataset and a suitable combination of various search strategies.

Also, the present disclosure may provide a hierarchical neural architecture search (hierarchical meta-architecture search) function in which the efficiency and scalability of domain expert architecture search capable of achieving high accuracy at customized inference costs are taken into consideration.

As described above, the apparatus and method for a hierarchical neural architecture search according to the present disclosure are not limitedly applied to the configurations and operations of the above-described embodiments, but all or some of the embodiments may be selectively combined and configured, so the embodiments may be modified in various ways.

What is claimed is:

1. An apparatus for a hierarchical hybrid neural architecture search, comprising:
one or more processors; and
memory for storing at least one program executed by the one or more processors,
wherein the at least one program
assigns a data subset per cluster by retrieving semantic clustering information with meta-feature information similar to target data for a neural architecture search from a large-scale dataset,
determines optimal meta-blocks by performing top-k meta-blocks search in the data subset assigned per cluster,
scales a size of a neural network model, and
determines a neural network architecture based on semantic information of meta-features obtained by combining the optimal meta-blocks.

2. The apparatus of claim 1, wherein the at least one program performs semantic clustering of multiview meta-features for distinguishing a proxy set from a large-scale dataset.

3. The apparatus of claim 2, wherein the at least one program generates semantic clustering information including vector information of meta-features of a pretrained latent embedding space based on the semantic clustering.

4. The apparatus of claim 1, wherein the at least one program assigns the meta-feature information similar to the target data for the neural architecture search as the data subset per cluster by performing task similarity representation learning based on vector information of meta-features provided from a proxy set of the large-scale dataset.

5. The apparatus of claim 1, wherein the at least one program searches for a preset number of top optimal meta-blocks with a high probability, among predicted meta-blocks, by performing the top-k meta-blocks search.

6. The apparatus of claim 5, wherein the at least one program performs the top-k meta-blocks search by determining a routing branch for mapping to a feature group of each layer that is preset for each feature of data in the data subset per cluster.

7. The apparatus of claim 6, wherein the at least one program performs the top-k meta-blocks search by utilizing a block-wise search function using supervised learning according to a data subset based on the meta-feature information and a multiple-branch hybrid method for selecting a branch of an inference path from multiple branches based on the routing branch.

8. The apparatus of claim 1, wherein the meta-feature information is configured in a form of a feature matrix based on instance representation information, which represents features of a dataset in a meta-feature latent embedding space, and cluster representation information, which represents a normal distribution of data of the dataset.

9. The apparatus of claim 1, wherein the at least one program combines the optimal meta-blocks and generates the semantic information based on multiview meta-features extracted by applying a result of scaling the size of the neural network model to a reference base architecture.

10. The apparatus of claim 9, wherein the at least one program combines the optimal meta-blocks using a predefined Markov-chain-based evolution algorithm and scales the size of the neural network model.

11. A method for a hierarchical hybrid neural architecture search, performed by an apparatus for the hierarchical hybrid neural architecture search, comprising:
assigning a data subset per cluster by retrieving semantic clustering information with meta-feature information similar to target data for a neural architecture search from a large-scale dataset;
determining optimal meta-blocks by performing top-k meta-blocks search in the data subset assigned per cluster; and
scaling a size of a neural network model and determining a neural network architecture based on semantic information of meta-features obtained by combining the optimal meta-blocks.

12. The method of claim 11, further comprising:
performing semantic clustering of multiview meta-features for distinguishing a proxy set from a large-scale dataset.

13. The method of claim 12, wherein performing the semantic clustering comprises generating semantic clustering information including vector information of meta-features of a pretrained latent embedding space based on the semantic clustering.

14. The method of claim 11, wherein assigning the data subset comprises assigning the meta-feature information similar to the target data for the neural architecture search as the data subset per cluster by performing task similarity representation learning based on vector information of meta-features provided from a proxy set of the large-scale dataset.

15. The method of claim 11, wherein determining the optimal meta-blocks comprises searching for a preset number of top optimal meta-blocks with a high probability, among predicted meta-blocks, by performing the top-k meta-blocks search.

16. The method of claim 15, wherein determining the optimal meta-blocks comprises performing the top-k meta-blocks search by determining a routing branch for mapping to a feature group of each layer that is preset for each feature of data in the data subset per cluster.

17. The method of claim 16, wherein determining the optimal meta-blocks comprises performing the top-k meta-blocks search by utilizing a block-wise search function using supervised learning according to a data subset based on the meta-feature information and a multiple-branch hybrid method for selecting a branch of an inference path from multiple branches based on the routing branch.

18. The method of claim 11, wherein the meta-feature information is configured in a form of a feature matrix based on instance representation information, which represents features of a dataset in a meta-feature latent embedding space, and cluster representation information, which represents a normal distribution of data of the dataset.

19. The method of claim 11, wherein determining the neural network architecture comprises combining the optimal meta-blocks and generating the semantic information based on meta-features extracted by applying a result of scaling the size of the neural network model to a reference base architecture.

20. The method of claim 19, wherein determining the neural network architecture comprises combining the optimal meta-blocks using a predefined Markov-chain-based evolution algorithm and scaling the size of the neural network model.
